(19) United States
(12) Patent Application Publication
(10) Pub. No.: US 2025/0353977 A1
(43) Pub. Date: Nov. 20, 2025

(54) PREPARING A FLEXIBLE DISPLAY SUBSTRATE WITH A MIXTURE OF TETRA ACIDS OR TETRA ACID DERIVATIVES AND POLYAMIC ACIDS

(71) Applicant: Akron Polymer Systems, Inc., Akron, OH (US)

(72) Inventors: Zhen Li, Hudson, OH (US); Lang Hu, Tallmadge, OH (US); Limin Sun, Copley, OH (US); Frank W. Harris, Boca Raton, FL (US); Dong Zhang, Hudson, OH (US)

(21) Appl. No.: 18/667,014

(22) Filed: May 17, 2024

(51) Int. Cl. C08J 5/18; B29C 39/00; B29C 39/38; B29K 79/00; B29K 105/00; B29L 31/34; C08G 73/10

(52) U.S. Cl. CPC C08J 5/18; C08G 73/1028; C08G 73/1082; B29C 39/003; B29C 39/38; B29K 2079/08; B29K 2105/0073; B29K 2105/0094; B29K 2909/08; B29K 2995/002; B29K 2995/0097; B29L 2031/3475; C08J 2379/08

(57) ABSTRACT

A process for the preparation of an aromatic polyimide substrate for optical displays that can be carried out during the manufacture of a display, which includes the steps of coating a solution of an aromatic tetracarboxylic acid or an aromatic tetracarboxylic acid derivative and a low molecular weight polyamic acid on a solid support and subsequent heating. The polyamic acid is prepared from non-stoichiometric amounts of 3,3′,4,4′-biphenyltetracarboxylic dianhydride and p-phenylenediamine.

### FIELD OF THE INVENTION

The invention relates to a process for preparing a flexible polyimide film substrate for optical displays. The flexible substrate is prepared by casting a solution of a tetracarboxylic acid or a tetracarboxylic acid derivative and a polyamic acid onto a solid substrate and heating it to high temperatures. Importantly, for processing, the solution has a low viscosity and high solids content. The process, which can be carried out during the manufacture of the displays, results in a film substrate with excellent mechanical, optical, and thermal properties.

### BACKGROUND OF THE INVENTION

Flexible displays are under development that are light, thin, and robust so there are unlimited product design possibilities. Compared to liquid crystal displays (hereinafter abbreviated as LCDs), organic light-emitting diode (hereinafter abbreviated as OLED) displays have a simpler structure and are more suitable for making flexible displays. The market size of OLED displays has been increasing rapidly for the past several years. OLED displays have high luminous efficiency and high contrast, and are widely used in mobile phones, digital cameras, navigators, commercial signs, etc. A major factor in their increased use in these areas has been the development of active-matrix OLEDs (hereinafter abbreviated as AMOLED) which provide low energy consumption, fast response times, and high resolution. These highly desirable properties depend largely on the processing temperature of the AMOLED electronic components. In their manufacture, the thin film transistor (hereinafter abbreviated as TFT) array of the AMOLED is deposited on a rigid substrate at high temperatures. The deposition temperature has a significant influence on the electronic characteristics of the TFT. Glass is the normal rigid substrate material because it can withstand extremely high deposition temperatures (greater than 500° C.), resulting in TFTs with excellent performance characteristics. But the glass itself is thick, heavy, and fragile, which limits the design and diversity of display products. This had led to mobile phone makers searching for materials to make lightweight, thin, and unbreakable displays. This has led to the search for polymer-based substrate materials, which could enable such flexible displays. Due to their low small specific gravity, good flexibility, robustness, and ability to be made into thin films, polymer materials are ideal candidates for substrate materials in flexible electronic devices. Thus, there has been considerable effort to develop manufacturing processes for such devices. WO2005/050754 discloses a process whereby a parylene film is deposited on a rigid substrate followed by the construction of an electronic device on the film surface. The finished device is released from the rigid substrate so that parylene film functions as the device substrate. However, parylene is not thermally stable enough to withstand the processing temperatures needed for most displays.

Aromatic polyimides are known for their excellent thermal and mechanical properties and are the best candidates for flexible display substrate materials. In the classic polyimide preparation process, an aromatic dianhydride and an aromatic diamine are polymerized in a solvent to form a soluble precursor polyamic acid, which is solution cast into a film, and then imidized at high temperatures to yield a polyimide film. Among various polyimides, those based on 3,3′,4,4′-biphenyltetracarboxylic dianhydride (hereinafter abbreviated as BPDA), pyromellitic dianhydride (hereinafter, may be abbreviated as PMDA) and p-phenylenediamine (hereinafter abbreviated as p-PDA) are especially desirable since they have excellent mechanical properties. These properties are related to their rigid and linear macromolecular structure. Their fully aromatic structure also results in a high thermal decomposition temperature. Japanese patents 5650458 and 6288227 disclose processes where solutions of polyamic acids prepared from these monomers are coated on rigid carrier plates to form films that are thermally imidized, followed by the construction of an electronic device on the film surface. The rigid substrate is separated from the plate to yield a flexible device. However, solutions of polyamic acids prepared from BPDA, PMDA, and p-PDA exhibit high solution viscosity, which makes the film fabrication process difficult. WO 2017/204186, U.S. Pat. No. 8,354,493, and US Patent Application Publication 2020/0407593 disclose processes to lower the polyamic acid molecular weight by end-capping the polymer with mono-anhydrides. Although lowering the molecular weight can lower the viscosity, low molecular weight will lead to reduced film performance, in particular reduced elongation. Thus, a process that uses a solution with high solids content and a low solution viscosity that can be used to generate a substrate with excellent mechanical, optical, and thermal properties during the manufacture of a display has been difficult to achieve.

### SUMMARY OF THE INVENTION

A process for the preparation of an aromatic polyimide substrate for optical displays that can be carried out during the manufacture of a display, which includes the steps of coating a solution of an aromatic tetracarboxylic acid or an aromatic tetracarboxylic acid derivative and a low molecular weight polyamic acid on a solid support and subsequent heating to between 425° C. to 450° C. The polyamic acid is prepared from non-stoichiometric amounts of BPDA and p-PDA. The tetracarboxylic acid is 3,3′,4,4′-biphenyltetracarboxylic acid (hereinafter abbreviated as BPTA) or pyromellitic acid (hereinafter abbreviated as PMA) or their certain derivatives. The solution has a solids content between 15 to 25 percent by weight (hereinafter abbreviated as wt %) and an apparent viscosity between 2,000 to 10,000 centipoise (hereinafter abbreviated as cP). The substrate has an elongation to break (hereinafter abbreviated as ε_{break}) of greater than 30%, a modulus greater than 8 Gigapascal (hereinafter abbreviated as GPa), a maximum stress to break (hereinafter abbreviated as σₘₐₓ) greater than 400 Megapascal (hereinafter abbreviated as MPa), and a yellowness factor b *<25. Importantly for display manufacturing, the substrate also has a softening temperature above 450° C.

A process for the manufacture of a polyimide substrate that can be utilized during the manufacture of a display that employs a low viscosity, high solids content solution of a low molecular weight polyamic acid and a tetracarboxylic acid or a tetracarboxylic derivative is described. In this process the precursor solution is cast on a solid substrate and thermally converted to a film with excellent mechanical, optical and thermal properties.

The polyamic acid is prepared from BPDA and/or PMDA and p-PDA using between a 2 to 7% molar excess of p-PDA in a polar aprotic solvent. The monomers are polymerized by heating the solution to 50° C. for 2 hours. BPTA derivatives or PMA derivatives are added before or after polymerization. The molar ratio of (dianhydride plus tetracarboxylic acid derivatives)/p-PDA varies from 99/100 to 102/100. The solids content of the solution after the addition of the tetracarboxylic acid is between 15 wt % to 25 wt % and the solution viscosity is 2,000 cPs to 10,000 cPs. The solution is coated on a glass substrate, dried with hot air or under reduced pressure at 80° C. to 100° C. to remove solvent and then heated at a rate of 2° C. to 10° C./minute to between 425° C.-450° C. and held there for 10 minutes to 60 minutes (hereinafter abbreviated as min) under nitrogen. Alternatively, the heating cycle may be staged so that the sample is held at between 100° C. to 150° C. for between 10 min to 30 min, then between 150° C. to 250° C. for between 10 min to 30 min, and then to between 250° C. to 450° C. for between 10 min to 30 min. The polyimide films obtained in this manner have elongations at break greater than 30%, moduli greater than 8 GPa, and maxima stress at break greater than 400 MPa. The films also have a yellowness factor b *<25.

### DETAILED DESCRIPTION OF THE INVENTION

According to one aspect, the invention provides a process for the preparation of an aromatic polyimide substrate for optical displays that can be carried out during the manufacture of the display. The process includes steps of: casting a solution of an aromatic tetracarboxylic acid or an aromatic tetracarboxylic acid derivative and a low molecular weight polyamic acid in a polar organic solvent on a solid support in the form of a film. In some cases the polyamic acid is obtained by polymerizing 3,3′4,4′-biphenyltetracarboxylic dianhydride with an excess of p-phenylenediamine. The aromatic tetracarboxylic acid and aromatic tetracarboxylic acid derivative having the following structures:

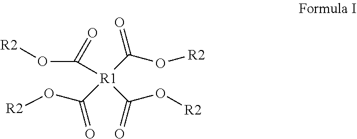

wherein R1 is,

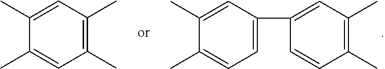

and wherein R2 is hydrogen or an alkyl group or mixtures of the two. The method continues after the casting step to include evaporating solvent to afford a polyamic acid film; and heating the polyamic acid film on the support to a temperature of at least 425° C. in order to prepare the aromatic polyimide substrate.

In some aspects, the process for the preparation of an aromatic polyimide substrate, the tetracarboxylic acid derivative is a 3,3′,4,4′-biphenyltetracarboxylic acid derivative or a pyromellitic acid derivative.

In some aspects, the process for the preparation of an aromatic polyimide substrate the tetracarboxylic acid derivative is a 3,3′,4,4′-biphenyltetracarboxylic acid derivative.

In some aspects, the process for the preparation of an aromatic polyimide substrate the four R2 groups in claim 1 are H or alkyl groups, the alkyl groups having one to four carbon atoms, wherein the number of H groups is no less than 2.

In some aspects, the process for the preparation of an aromatic polyimide substrate the molar ratio of 3,3′,4,4′-biphenyltetracarboxylic dianhydride to p-phenylenediamine is from about 93:100 to about 98:100 or from 93:100 to 98:100.

In some aspects, the process for the preparation of an aromatic polyimide substrate, the polyamic acid is prepared in the solution prior to the addition of the aromatic tetracarboxylic acid or aromatic tetracarboxylic acid derivative.

In some aspects, the process for the preparation of an aromatic polyimide substrate, the polyamic acid is prepared in the solution after the addition of the aromatic tetracarboxylic acid or aromatic tetracarboxylic acid derivative.

In some aspects, the process for the preparation of an aromatic polyimide substrate, the polyamic acid is prepared in the solution after the addition of the aromatic tetracarboxylic acid or aromatic tetracarboxylic acid derivative.

In some aspects, the process for the preparation of an aromatic polyimide substrate, the polar organic solvent is N,N-dimethylformamide, N,N-dimethylacetamide, N-methylpyrrolidone, N-ethylpyrrolidone, dimethylsulfoxide, or mixtures of these solvents.

In some aspects, the process for the preparation of an aromatic polyimide substrate, the polar organic solvent is N-methylpyrrolidone.

In some aspects, the process for the preparation of an aromatic polyimide substrate, the molar ratio of the aromatic tetracarboxylic acid or aromatic tetracarboxylic acid derivative plus 3, 3′,4,4′-biphenyltetracarboxylic dianhydride together to diamine is from about 99:100 to about 102:100, or from 99:100 to 102:100.

In some aspects, the process for the preparation of an aromatic polyimide substrate, the molar ratio of the aromatic tetracarboxylic acid or aromatic tetracarboxylic acid derivative plus 3, 3′,4,4′-biphenyltetracarboxylic dianhydride together to diamine is from about 99:100 to about 100:100, or 99:100 to 100:100.

In some aspects, the process for the preparation of an aromatic polyimide substrate, the optical display is constructed directly on the polyimide film on the support using known techniques comprising stripping the support from the polyimide film so that the electronics of the display are attached to the polyimide substrate.

In some aspects, the process for the preparation of an aromatic polyimide substrate, the solids content of the solution is from about 15 wt % to about 25 wt % and/or the solution apparent viscosity is from about 2,000 cPs to about 10,000 cPs at 25° C. In some aspects, the process for the preparation of an aromatic polyimide substrate, or the solids content of the solution is 15 to 25 wt % and the solution apparent viscosity is 2,000 cPs to 10,000 cPs at 25° C.

In some aspects, the process for the preparation of an aromatic polyimide substrate, the polyimide film is from about 5 μm to about 25 μm thick, or 5 μm to 25 μm thick.

In some aspects, the process for the preparation of an aromatic polyimide substrate the polyimide film has an elongation at break greater than 30%, a modulus greater than 8 GPa, and a maximum stress at break greater than 400 MPa. In some aspects, the process for the preparation of an aromatic polyimide substrate the polyimide film has an elongation at break at least about 30%, a modulus at least about 8 GPa, and a maximum stress at break at least about 400 MPa.

In some aspects, the process for the preparation of an aromatic polyimide substrate, the polyimide film has a yellowness factor of about b *<25, or of b *<25.

The objective of this invention is to provide a process where a 5-25 μm (hereinafter abbreviated as μm) polyimide film substrate having an elongation at break greater than 30%, a modulus greater than 8 GPa, a maximum stress at failure of greater than 400 MPa, and a yellowness b *<25 at the thickness of 10 μm can be produced during the manufacture of an optical display. Thus, a low molecular weight polyamic acid is prepared by the reaction of BPDA with excess p-PDA in a polar solvent such as N,N-dimethylformamide (hereinafter abbreviated as DMF), N,N-dimethylacetamide (hereinafter abbreviated as DMAc), N-methylpyrrolidone (hereinafter abbreviated as NMP), N-ethylpyrrolidone (hereinafter abbreviated as NEP), or dimethylsulfoxide (hereinafter abbreviated as DMSO) or their mixtures. NMP is the preferred solvent. The molar ratio of BPDA to p-PDA was varied from 93:100 to 98:100. Although the solution is best heated to 50° C. for 2 hours, other heating cycles can be used. The heating cycle and the offset in monomer ratio are used to help control the molecular weight of the resultant polyamic acid and, thus, the solution viscosity. A tetracarboxylic acid or a tetracarboxylic acid derivative is added either prior or after the reaction. The preferred additive is BPTA and its derivatives although PMA and its derivatives as well as other similar compounds may be used. The molar ratio of the additive to the polyamic acid varies from 2% to 8%. The molar ratio of (BPDA+BPTA derivatives)/p-PDA varied from 99/100 to 102/100. The solids content of the solution is set from 15 wt % to 25 wt % so that the solution viscosity is in the range of 2,000cPs-10,000 cPs at 25° C. The solution containing the two components is then cast on a glass plate, and the solvent removed by a stream of hot air or by heating under reduced pressure at 80° C.-100° C. for 30 min. The glass plate containing the resulting film is then heated at the rate of 1° C.-10° C./min with or without staging at intermediate temperatures to between 425° C. to 450° C. and held there for 10 min to 60 min. Preferably, the heating cycle is staged so that the sample is held at between 100° C. to 150° C. for between 10 min to 30 min, to between 150° C. to 250° C. for between 10 min to 30 min, and to between 250° C. to 450° C. for between 10 min to 30 min. In order to achieve the required thermal properties, in particular a softening temperature above 450° C., it has been discovered that the film must be heated to a minimum of 425° C. During this process, the polyamic acid chain extends by reacting with the tetracarboxylic acid or tetracarboxylic acid derivative and thermally imidizing. In this manner, a polyimide film is obtained that displays the targeted properties. This process can be the initial step in the manufacture of the display, which is conducted on the film surface. The final step is the stripping of the rigid substrate from the completed display so that the electronics of the display are now only attached to the polyimide film.

### Description of Experiments

### Film Preparation

The solution of the tetraacid or tetraacid derivative and the polyamic acid was poured on a glass substrate. The viscous solution was leveled and the eventual film thickness controlled using a doctor blade with different gaps. After the majority of the solvent was removed with hot air or by heating under reduced pressure between 80° C. to 100° C. for 30 min, the glass substrate was heated under nitrogen at the rate of 5° C. to 150° C./min and held there for 15 min; heated at the rate of 5° C./min to 250° C. and held for 15 min; heated at the rate of 5° C./min to 450° C. and held for 30 min. The resulting polyimide film was then peeled from the substrate.

### Solution Viscosity

The solution viscosity was measured at 25° C. using a Brookfield DV-I viscometer.

### Mechanical Properties

The mechanical properties of the film were measured using an INSTRON® 5969 Tensometer. Film samples with thicknesses between 10 μm to 20 μm were prepared from NMP solutions and tested at room temperature at a strain rate of 10 mm/min.

### Optical Properties

Optical properties of 10 μm films were determined on an Ultrascan® VIS Hunterlab. Yellowness factor b*, haze, and total transmission (hereinafter abbreviated as Ytotal) are used for comparison.

### EXAMPLES

### Synthesis example 1BP2Me2H synthesis. (2 of R2=Me, 2 of R2=H)

A 300 milliliter (hereinafter abbreviated as ml) round bottom flask equipped with a stirrer, a nitrogen inlet, and a condenser was charged with 100 g of methanol (hereinafter abbreviated as MeOH) and 20 g of BPDA. The solution was stirred and heated to reflux under nitrogen for 24 hours. All BPDA powder was dissolved. After cooling down, the excess MeOH was removed by rotor evaporation equipment. The BP2Me2H sample was further dried under vacuum to fully remove MeOH. The BP2Me2H product was a white solid. The product was characterized by NMR for chemical structure.

### Synthesis example 2BP2Et2H synthesis. (2 of R2=Et, 2 of R2=H)

A 300 ml round bottom flask equipped with a stirrer, a nitrogen inlet, and a condenser was charged with 100 g of ethanol (hereinafter abbreviated as EtOH) and 20 g of BPDA. The solution was stirred and heated to reflux under nitrogen for 24 hours. All BPDA powder was dissolved. After cooling down, the excess EtOH was removed by rotor evaporator equipment. The BP2Et2H sample was further dried under vacuum to fully remove EtOH. The BP2Et2H product was a white solid. The product was characterized by NMR for chemical structure.

### Synthesis example 3BP3Et1H synthesis. (3 of R2=Et, 1 of R2=H)

A 300 ml round bottom flask equipped with a stirrer, a nitrogen inlet, and a condenser was charged with 100 g of EtOH and 20 g of BPDA. 1% H2SO4 was then charged. The solution was stirred and heated to reflux under nitrogen for 18 hours. All BPDA powder was dissolved. After cooling down, the excess EtOH was removed by precipitation in water. The BP3Et1H sample was further dried under vacuum to fully remove EtOH and water. The BP3Et1H product was a white solid. The product was characterized by NMR for chemical structure.

### Synthesis example 4BP4MeOH synthesis. (4 of R2=Me, 0 of R2=H)

A 300 ml round bottom flask equipped with a stirrer, a nitrogen inlet, and a condenser was charged with 100 g of NMP and 20 g of BPDA. 1.3 eq of N,N-Dimethylformamide dimethyl acetal (hereinafter abbreviated as DMFDMA) was then charged. The solution was stirred and heated at 50° C. for 2 hours. All BPDA powder was dissolved. After cooling down, the solution was precipitated into water. The BP4MeOH sample was further dried under vacuum to fully remove solvents and water. The BP4MeOH product was a white solid. The product was characterized by NMR for chemical structure.

### Comparative Example 1

A 300 ml round bottom flask equipped with a mechanical stirrer, a nitrogen inlet, and a condenser was charged with 91.65 g of NMP and 50.00 millimole (hereinafter abbreviated as mmol) of p-PDA. Then 50.00 mmol of BPDA was added under nitrogen flow, the solid content was set to 18 wt %. The solution was stirred and heated at 50° C. under nitrogen for 2 hours. The solution became extremely viscous with an apparent viscosity greater than 400,000 cPs which is beyond the upper limit of viscometer. Because the viscosity of the solution was so high, it was difficult to cast a smooth film. Due to the difficulty in casting a flat film, the physical parameters of the film could not be determined.

### Comparative Example 2

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 12.64 g of NMP was added and mixed well, reducing the solids content to 20.0 wt %. The solution had an apparent viscosity of 3980 cPs.

### Comparative Example 3

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 2.50 mmol BP4MeOH and 16.50 g NMP were added and mixed well, reducing the solids content to 20.0 wt %. The solution had an apparent viscosity of 3190 cPs.

### Comparative Example 4

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 2.50 mmol BP3Et1H and 16.78 g NMP were added and mixed well, reducing the solids content to 20.0 wt %. The solution had an apparent viscosity of 3240 cPs.

### Example 1

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 2.00 mmol BP2Et2H and 15.73 g NMP were added and mixed well, reducing the solids content to 20.0 wt %. The solution had an apparent viscosity of 3200 cPs.

### Example 2

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 2.50 mmol BP2Et2H and 16.50 g NMP were added and mixed well, reducing the solids content to 20.0 wt %. The solution had an apparent viscosity of 3100 cPs.

### Example 3

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 3.00 mmol BP2Et2H and 17.28 g NMP were added and mixed well, reducing the solids content to 20.0 wt %. The solution had an apparent viscosity of 3220 cPs.

### Example 4

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 3.50 mmol BP2Et2H and 18.05 g NMP were added and mixed well, reducing the solids content to 20.0 wt %. The solution had an apparent viscosity of 3290 cPs.

### Example 5

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 2.00 mmol BP2Me2H and 15.51 g NMP were added and mixed well, reducing the solids content to 20.0 wt %. The solution had an apparent viscosity of 3480 cPs.

### Example 6

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 2.50 mmol BP2Me2H and 16.22 g NMP were added and mixed well, reducing the solids content to 20.0 wt %. The solution had an apparent viscosity of 3260 cPs.

### Example 7

A 300 ml round bottom flask equipped with a stirrer, a nitrogen inlet, and a condenser was charged with 64.89 g of NMP and 50.00 mmol of p-PDA. Then 47.50 mmol of BPDA was added under nitrogen flow. The solution was stirred and heated to 50° C. under nitrogen for 2 hours. Subsequently, 3.00 mmol BP2Me2H and 16.94 g NMP were added and mixed well, reducing the solids content to 20.0 wt %. The solution had an apparent viscosity of 3080 cPs.

Comparative example 2, which was made without BPTA derivatives, had a b* value higher than 30. Comparative examples 3 and 4, in which the number of attached derivatives was equal to or larger than 3, had b* values higher than 30.

Examples 1-7, in which BP2Et2H and BP2Me2H were used, all have b* values were less than 25.

TABLE 1
BPTA derivative addition. Optical data:

| | Addition of | Amount | (BPDA + | | | Y |
|---|---|---|---|---|---|---|
| Examples | derivative | Mol | Derivative):PDA | b* | Haze | total |
| Comparative example 2 | None | 0% | 95:100 | 34.6 | 0.24 | 79.8 |
| Comparative example 3 | BP4MeOH | 5% | 100:100 | 34.4 | 0.21 | 75.3 |
| Comparative example 4 | BP3Et1H | 5% | 100:100 | 33.3 | 0.24 | 76.1 |
| Example 1 | BP2Et2H | 4% | 99:100 | 24.3 | 0.19 | 81.7 |
| Example 2 | BP2Et2H | 5% | 100:100 | 20.8 | 0.15 | 82.5 |
| Example 3 | BP2Et2H | 6% | 101:100 | 19.8 | 0.16 | 82.4 |
| Example 4 | BP2Et2H | 7% | 102:100 | 20.0 | 0.15 | 81.0 |
| Example 5 | BP2Me2H | 4% | 99:100 | 24.7 | 0.2 | 81.5 |
| Example 6 | BP2Me2H | 5% | 100:100 | 20.9 | 0.14 | 82.2 |
| Example 7 | BP2Me2H | 6% | 101:100 | 20.2 | 0.15 | 81.8 |

TABLE 2
BPTA derivative addition. Mechanical properties:

| | Addition of | (BPDA + | Modulus | σₘₐₓ | ε_{break} |
|---|---|---|---|---|---|
| Examples | derivative | Derivative):PDA | Gpa | Mpa | (%) |
| Comparative example 2 | None | 95:100 | 8.5 ± 0.4 | 290 ± 30 | 11 ± 4 |
| Comparative example 3 | BP4Me0H | 100:100 | 8.1 ± 0.4 | 320 ± 40 | 14 ± 4 |
| Comparative example 4 | BP3Et1H | 100:100 | 8.1 ± 0.3 | 320 ± 20 | 12 ± 3 |
| Example 1 | BP2Et2H | 99:100 | 8.3 ± 0.2 | 450 ± 50 | 30 ± 6 |
| Example 2 | BP2Et2H | 100:100 | 8.3 ± 0.2 | 460 ± 50 | 33 ± 9 |
| Example 3 | BP2Et2H | 101:100 | 8.3 ± 0.2 | 470 ± 40 | 30 ± 5 |
| Example 4 | BP2Et2H | 102:100 | 8.2 ± 0.2 | 430 ± 30 | 30 ± 4 |
| Example 5 | BP2Me2H | 99:100 | 8.2 ± 0.2 | 480 ± 50 | 35 ± 8 |
| Example 6 | BP2Me2H | 100:100 | 8.2 ± 0.2 | 520 ± 50 | 37 ± 4 |
| Example 7 | BP2Me2H | 101:100 | 8.2 ± 0.2 | 470 ± 20 | 33 ± 3 |

The films prepared in comparative examples 2 from polyamic acid solutions not containing BPTA derivatives had poor mechanical properties. Comparative examples 3 and 4, in which the number of attached derivatives was equal to or larger than 3, had poor mechanical properties. The elongation at break was less than 20%. The maximum stress at break was also less than 400 MPa.

The films prepared in examples 1-7 from solutions containing BPTA derivatives had excellent mechanical properties, in these solutions the molar ratio of BPTA derivatives and BPDA to PDA was close to 100:100. All the samples had elongations at break higher than 30% and the maximum stress at break was greater than 400 MPa. Also importantly, all the film b* values were less than 25.

To the extent that the term “includes” or “including” is used in the specification or the claims, it is intended to be inclusive in a manner similar to the term “comprising” as that term is interpreted when employed as a transitional word in a claim. “Consisting of” is a term applied to a composition containing only recited elements, for example A and B. “Consisting essentially of” is a term applied to a composition containing recited elements, A and B but may additionally contain materially inert compounds such as water, EtOH, or solvent. Furthermore, to the extent that the term “or” is employed (e.g., A or B) it is intended to mean “A or B or both.” When “only A or B but not both” is intended, then the term “only A or B but not both” will be employed. Thus, use of the term “or” herein is the inclusive, and not the exclusive use. As used in the specification and the claims, the singular forms “a,” “an,” and “the” include the plural. Finally, where the term “about” is used in conjunction with a number, it is intended to include±1% of the number. For example, “about 10” may mean from 9 to 11. The term wt % is meant to describe a comparison of the weight of one compound to the weight of the whole composition expressed as a percent. It can also be described as wt. %, or (w/w) %.

As stated above, while the present application has been illustrated by the description of embodiments, and while the embodiments have been described in considerable detail, it is not the intention to restrict or in any way limit the scope of the appended claims to such detail. Additional advantages and modifications will readily appear to those skilled in the art, having the benefit of this application. Therefore, the application, in its broader aspects, is not limited to the specific details and illustrative examples shown. Departures may be made from such details and examples without departing from the spirit or scope of the general inventive concept.

We claim:

1. A process for the preparation of an aromatic polyimide substrate for optical displays that can be carried out during the manufacture of the display, the process comprising the steps of:
casting a solution of an aromatic tetracarboxylic acid or an aromatic tetracarboxylic acid derivative and a low molecular weight polyamic acid in a polar organic solvent on a solid support in the form of a film, said polyamic acid obtained by polymerizing 3,3′4,4′-biphenyltetracarboxylic dianhydride with an excess of p-phenylenediamine, said aromatic tetracarboxylic acid and aromatic tetracarboxylic acid derivative having the structures: 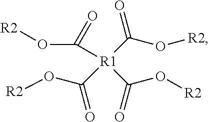
wherein R1 is, 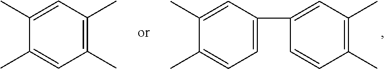
and wherein R2 is hydrogen or an alkyl group or mixtures of the two;
evaporating solvent to afford a polyamic acid film; and
heating the polyamic acid film on the support to a temperature of not lower than 425° C. to prepare the aromatic polyimide substrate.

2. The process for the preparation of an aromatic polyimide substrate of claim 1, wherein the tetracarboxylic acid derivative is a 3,3′,4,4′-biphenyltetracarboxylic acid derivative or a pyromellitic acid derivative.

3. The process for the preparation of an aromatic polyimide substrate of claim 1, wherein the tetracarboxylic acid derivative is a 3,3′,4,4′-biphenyltetracarboxylic acid derivative.

4. The process for the preparation of an aromatic polyimide substrate of claim 1, wherein the four R2 groups in claim 1 are H or alkyl groups, the alkyl groups having one to four carbon atoms, wherein the number of H groups is no less than 2.

5. The process for the preparation of an aromatic polyimide substrate of claim 1 wherein the molar ratio of 3,3′,4,4′-biphenyltetracarboxylic dianhydride to p-phenylenediamine is from 93:100 to 98:100.

6. The process for the preparation of an aromatic polyimide substrate of claim 1, wherein the polyamic acid is prepared in the solution prior to the addition of the aromatic tetracarboxylic acid or aromatic tetracarboxylic acid derivative.

7. The process for the preparation of an aromatic polyimide substrate of claim 1, wherein the polyamic acid is prepared in the solution after the addition of the aromatic tetracarboxylic acid or aromatic tetracarboxylic acid derivative.

8. The process for the preparation of an aromatic polyimide substrate of claim 1 where the polar organic solvent is N,N-dimethylformamide, N,N-dimethylacetamide, N-methylpyrrolidone, N-ethylpyrrolidone, dimethylsulfoxide, or mixtures of these solvents.

9. The process for the preparation of an aromatic polyimide substrate of claim 1 where the polar organic solvent is N-methylpyrrolidone.

10. The process for the preparation of an aromatic polyimide substrate of claim 1 where the molar ratio of the aromatic tetracarboxylic acid or aromatic tetracarboxylic acid derivative plus 3, 3′,4,4′-biphenyltetracarboxylic dianhydride together to diamine is from 99:100 to 102:100.

11. The process for the preparation of an aromatic polyimide substrate of claim 1, wherein the molar ratio of the aromatic tetracarboxylic acid or aromatic tetracarboxylic acid derivative plus 3, 3′,4,4′-biphenyltetracarboxylic dianhydride together to diamine is from 99:100 to 100:100.

12. The process for the preparation of an aromatic polyimide substrate of claim 1, wherein an optical display is constructed directly on the polyimide film on the support using known techniques comprising stripping the support from the polyimide film so that the electronics of the display are attached to the polyimide substrate.

13. The process for the preparation of an aromatic polyimide substrate of claim 1, wherein the solids content of the solution is 15 wt % to 25 wt % and the solution apparent viscosity is 2,000 cPs to 10,000 cPs at 25° C.

14. The process for the preparation of an aromatic polyimide substrate of claim 1 where the polyimide film is 5 μm-25 μm thick.

15. The process for the preparation of an aromatic polyimide substrate of claim 1 where the polyimide film has an elongation at break greater than 30%, a modulus greater than 8 GPa, and a maximum stress at break greater than 400 MPa.

16. The process for the preparation of an aromatic polyimide substrate of claim 1, wherein the polyimide film has a yellowness factor b *<25.
